(19) United States
(12) Patent Application Publication
(10) Pub. No.: US 2003/0088437 A1
(43) Pub. Date: May 8, 2003

(54) Method for identifying skin conditions, selecting suitable treatment products, or predicting product efficacy

(76) Inventors: Susanne Teklits Iobst, Maywood, NJ (US); Ian Richard Scott, Allendale, NJ (US); Kurt Matthew Schilling, Totowa, NJ (US); Miles Hugh Eddowes, Edgewater, NJ (US)

Correspondence Address: UNILEVER, PATENT DEPARTMENT, 45 RIVER ROAD, EDGEWATER, NJ, 07020, US

(21) Appl. No.: 10/254,417

(22) Filed: Sep. 25, 2002

Related U.S. Application Data
(60) Provisional application No. 60/337,895, filed on Nov. 8, 2001.

(51) Int. Cl. G06F 17/60

(52) U.S. Cl. 705/2

(57) ABSTRACT

A method of providing a system of selecting a treatment product for a skin condition of a consumer, by collecting information from the consumer regarding a plurality of characteristics associated with the skin condition; inputting the information into a computerized knowledge system, based on gene expression and other data collected from a population of individuals, that selects a product that will be effective for the consumer from at least two products that are effective against the skin condition; and providing the consumer with the treatment product for treating the skin condition. The business method of this invention uses a system with an integrated database that allows for continuous updating and reviewing.

This application claims priority under 35 U.S.C. 119 from U.S. provisional application Serial No. 60/337,895 filed Nov. 8, 2001, and incorporated by reference herein.

### FIELD OF THE INVENTION

The present invention relates to a method and system of identifying skin conditions, and more particularly, to a method of identifying skin conditions using a knowledge database and selecting suitable treatment products. The present invention is also directed to a method for predicting or monitoring the efficacy of a product.

### BACKGROUND OF THE INVENTION

Consumers purchase topical products to improve the characteristics of their skin. Such products may be obtained in a variety of forms, including oils, ointments, creams, lotions, and gels. The products may be used to treat a variety of conditions, such as acne, wrinkles, psoriasis, hair loss, age spots, and skin discoloration. Unfortunately, many consumers purchase topical products that do not work for their particular condition. For instance, a particular consumer may purchase a cream to treat acne and, not until after the product has been used for its intended use period, learn that the product does not work for them. The scientific basis for the existence of “responders” and “non-responders” to any particular product technology is unclear. Accordingly it is not possible to determine who will be a responder without actually testing the product on that individual. This leads to people having to self experiment with different products until they find one that works for them.

In the absence of a scientific, theory based, understanding of the basis of “responders” and “non-responders” it is possible in principle to identify such groups empirically by constructing a large correlation matrix between measured properties of the person and the response of that person to different technologies. Unfortunately, the fact that it is usually only possible to test one product at a time per person makes the size of studies needed to produce a statistically significant correlation totally impractical. Accordingly, no satisfactory predictive method to identify “responders” and “non responders” to a set of technologies has been established.

Measuring the skin needs of an individual and thereby recommending a generic product treatment is known. Examples would include establishing that an individual has acne and therefore recommending an acne treatment. Another example would be establishing that an individual has oily skin and therefore recommending an oil free moisturiser. Specific embodiments of this kind of “diagnostic” include the well known “Clinique Computer” found in department stores worldwide, as well as the Reflect.com website through which recommended products may be purchased. Further, WO 01/58238 (assigned to Collaborative Technologies) relates to a method and system for producing customized cosmetic and pharmaceutical formulations on demand based on retrieving a user profile associated with the user. There are also many examples of non invasive skin measurements that correlate with an individual having a particular type of skin problem such as sebumeters, skin impedance devices, profilometry and the like. Procter & Gamble's Visia Complexion Analysis System (a photographic imaging tool that provides clinical measurement and analysis of topical and subsurface facial skin conditions) is a specific example.

On their own however none of these systems can determine which of two technologies, each efficacious when tested on an “average” population, will work best on a particular individual. This remains an unachievable ambition in personal care and it is to this need that this invention is addressed.

### SUMMARY OF THE INVENTION

The invention relates to a method of providing a system of selecting a treatment product for a skin condition of a consumer, including:

(a) collecting information from the consumer regarding a plurality of characteristics associated with the skin condition, the information collected through a computer;

(b) inputting the information into a computerized knowledge system that selects a product that will be effective for the consumer from at least two products that are effective against the skin condition; and

(c) providing the consumer with the treatment product for treating the skin condition.

The computerized knowledge system is derived from a correlation between responses of a population of individuals to a plurality of products and measured characteristics of each of the individuals taken prior to use of the plurality of products.

In another aspect, the invention is directed to a method of predicting the efficacy of a product.

In a still further aspect, the invention is directed to a method of providing feedback to the consumer as to how the product is working.

### DETAILED DESCRIPTION OF THE INVENTION

As used herein, the following terms are intended to have the stated definitions.

The term “skin” as used herein includes the skin on the face, neck, chest, back, arms, hands, legs, and scalp. The term “skin” includes all layers of the human skin, including any reference to epidermis or keratinocytes.

As used herein, the term “comprising” includes made up of, composed of, including, consisting and/or consisting essentially of. Except in the operating and comparative examples, or where otherwise explicitly indicated, all numbers in this description indicating amounts or ratios of material or conditions of reaction, physical properties of materials and/or use are to be understood as modified by the word “about”.

The present invention relates to a method of predicting which of a plurality of products will be most efficacious for a particular individual. Preferably, the present invention is based on a method for detecting a skin condition in a skin sample using gene arrays as markers of the skin condition. The method further relates to product selection and/or monitoring based on a computerized knowledge base that contains data from physical skin samples analyzed by various gene expression techniques, as well as data based on feedback from product selections. Part of the method is a knowledge base that is constantly updated with data from new skin samples and with data from ongoing product selections and feedback. The inventive method is based on a series of steps.

Step 1 is the creation of a computerised knowledge base correlating parameters of a population of individuals measured before any product treatment, with the efficacy of a range of different technologies measured simultaneously on each member of that population.

The measured parameters can include questionaire data (age, sex, history of skin problems, self description of skin type etc), clinical data (appearance of wrinkles, extent of blemishes, skin color and tone etc) and instrumental data (chemical analysis, electrical properties, optical properties, mechanical properties etc). Only those parameters which significantly correlate with response of individuals to the different treatments are used in the knowledge base.

The creation of this knowledge base is only practical if it is possible to simultaneously measure the skin improvement from multiple products at the same time on the same individual. Achievement of these simultaneous multiple measurements is a major challenge. It requires that the benefit of the product be measurable in a reasonable period of time after product applications and that the benefit be measurable when the product is applied to only a small area of skin so that multiple products can be simultaneously applied. This is particularly challenging when the benefit is one such as anti-aging, where, conventionally, efficacy of single products can only be assessed when tested on the whole face for several months. The invention encompasses the use of known techniques, for this multiple performance assessment such as:

Measuring change in skin color of a small area of skin to predict the performance of cosmetic skin lightening agents

Measuring the change in skin impedance of a small area of skin to assess the performance of dry skin treatment

Measuring changes in skin auto-fluorescence of a small area of skin following product treatment to predict the performance of anti-aging products

Electrical conductivity of the skin

Sebum measurement of the skin

Microscopic analysis of the skin

The essential characteristic of these assessment methods is that they can be reliably applied to a small area of skin and provide accurate predictions of the effect of the product when applied to the skin in the normal way.

In a preferred embodiment of the invention, a novel and inventive technique for measuring product efficacy is used. We have discovered that it is possible to measure changes in the expression levels of genes in the skin that occur soon after product application commences and that these changes are predictive of whether the product will produce good, average or poor efficacy when treatment is continued for much longer periods. This is particularly advantageous for skin conditions such as ageing where normally very long periods of treatment are needed to achieve measurable benefits. The changes in gene expression level can be detected in small biopsies taken from the treatment site which are analysed by any of the methods known in the literature such as gene arrays, RT PCR or multiplexed methods.

Step 2 is to measure the parameters shown in step 1 on a consumer who is seeking guidance as to which product will be most efficacious for her, to correlate with response to different products. Those parameters are entered into the computerized knowledge system and a prediction of which product will work best for her is generated. The product is then provided to the consumer.

The following specific examples further illustrate the invention, but the invention is not limited thereto.

### EXAMPLE 1

In this example, DNA array technique is used to generate data on early changes in gene expression following product application.

DNA Array Technique. The following are the steps of this method.

1. Plasmid DNA, cDNA (copy DNA) generally in the range of 200-1000 bp or oligonucleotides (ranging from 20-100 bp) is attached to a support (this is either glass or nylon membrane). Since DNA is negatively charged, the surface of glass or membrane is positively charged, allowing the DNA to be “spotted” onto this solid support and be retained. Each DNA can represent a different gene, so that hundreds or thousands of genes can be studied at a single timepoint.

2. tRNA (total RNA) or mRNA (messenger RNA) is isolated from a sample (tissue, cells) and labeled either with a fluorescent tag, or radioisotope tag using a reverse transcription step. This serves as the probe.

3. This probe is then incubated with the array in solution. Where the sequence of the probe is complementary to the sequence on the array, the 2 spots are said to hybridize. This is then detected by phosphoroimaging, or using laser or other fluorescent detection techniques.

4. The signal from the detection system is analyzed via image analysis and quantified.

The probe may be used to test multiple products on a single skin sample of a single individual, as well as of a population. It may also be used to test different concentrations of an active component on a single skin sample of a single individual. Additionally, it may be used to test different combinations of actives on a single skin sample of a single individual.

### EXAMPLE 2

This example demonstrates a predictive method to identify “responders” and “non responders” to a set of skin benefit technologies, which is one of the key elements of the methods of the present invention.

Six panelists applied a prototype anti-aging topical skin care cream product (retinol/glycolic acid, as set forth in the Table below) to one of their arms twice daily for 12 weeks. The product composition is set forth in the Table below. Skin biopsies were taken before and after just 7 days of using the product and the epidermal tissue analysed for the levels of expression of key genes on Integriderm™ nylon gene arrays (Research Genetics). The benefit achieved over the 12 weeks of use was judged by an expert grader on the Crepey grade (Weinkauf, R. L., et al., “Method for Assessing the Efficacy of Cosmetic Formulations Containing Alpha Hydroxy Acids on Photoaged Skin of the Forearms,” Poster Presentation at American Academy of Dermatology (AAD) Meeting, incorporated by reference herein) and expressed as an integrated effect over the 12 weeks of use compared to an untreated control site.

TABLE 1

| | CHEMICAL/ | | COMP. 1 |
|---|---|---|---|
| PHASE | CTFA NAME | TRADE NAME | (WT. %) |
| A | WATER, DI | | 44.0 |
| A | DISODIUM EDTA | SEQUESTERENE Na2 | 0.05 |
| A | MAGNESIUM ALUMINUM | VEEGUM ULTRA | 0.6 |
| | SILICATE | | |
| A | METHYL PARABEN | METHYL PARABEN | 0.15 |
| A | SIMETHICONE | ANTIFOAM EMULSION | 0.01 |
| A | BUTYLENE GLYCOL - 1,3 | BUTYLENE GLYCOL - 1,3 | 3.0 |
| A | HYDROXYETHYLCELLULOSE | NATROSOL 250 HHR | 0.5 |
| A | GLYCERIN USP | GLYCERIN USP | 2.0 |
| A | XANTHAN GUM | KELTROL M | 0.2 |
| A | TRIETHANOLAMINE 99% | TEA 99% | 1.2 |
| B | STEARIC ACID | PRISTERENE 4911 | 3.0 |
| B | GLYCERYL | NATURECHEM GMHS | 1.5 |
| | HYDROXYSTEARATE¹ | | |
| B | STEARYL ALCOHOL | LANETTE 18DEO | 1.5 |
| B | CHOLESTEROL NF | CHOLESTEROL NF | 0.5 |
| B | SORBITAN STEARATE | SORBITAN STEARATE | 1.0 |
| B | PEG-100 STEARATE | MYRJ 59 | 2.0 |
| B | ISOSTEARYL PALMITATE² | PROTACHEM ISP | 6.0 |
| B | C12-C15 ALCOHOLS | HESTESTER FAO | 3.0 |
| | OCTANOATE | | |
| B | DIMETHICONE | SILICONE FLD 200 | 1.0 |
| | | (50 CTS) | |
| B | TOCOPHERYL ACETATE | VITAMIN E ACETATE | 0.10 |
| B | BUTYLATED | BHT | 0.05 |
| | HYDROXYTOLUENE | | |
| B | PROPYLPARABEN NF | PROPYLPARABEN | 0.1 |
| C | WATER, DI | | 3.0 |
| D | GLYCOLIC ACID 70% | GLYPURE 70 | 11.4 |
| D | AMMONIUM HYDROXIDE 29% | AMMONIUM HYDROXIDE 29% | 2.5 |
| D | WATER, DI | | 99.51 |
| A | WATER, DI | | 44.0 |
| E | RETINOL (51.3%)¹ | RETINOL BLEND (51.3%) | 0.29 |
| F | ALPHA-BISABOLOL | ALPHA-BISABOLOL | 0.2 |

¹A blend containing retinol 51.3%, BHA 0.6%, BHT 3.1% and Tween 20 45%.

The following table shows the correlation of changes in levels of the key genes after just 7 days of products usage, with the ultimate clinical benefit achieved. Panelists showing improvement had one set of gene patterns, while those showing no improvement had another set of gene patterns. The Performance Quotient, shown in column 2 of the table, is a ratio of visual assessments made on a Crepey scale after treatment to that before treatment. Performance Quotient was calculated by integrating the differences in Crepey grade (Weinkauf et al.) recorded from the two arms of each panelist over the 12 weeks of treatment where one arm is treated and the other untreated). The lower the numbers on the Crepey scale and the smaller the performance quotient, the fewer wrinkles. With reference to columns 3-5, “day 0” indicates gene expression prior to product application.

TABLE 2

| | | Relative fold change of gene | | |
|---|---|---|---|---|
| | | expression between | | |
| Performance ranking | Performance | day 0 and day 7 of treatment | | |
| (1 = Best, 6 = Worst) | Quotient | Gene 1 | Gene 2 | Gene 3 |
| 1 | 11.5 | 0.43 | 2.11 | 1.32 |
| 2 | 11.5 | 0.85 | 1.24 | 1.24 |
| 3 | 10.0 | 0.51 | 1.64 | 1.32 |
| 4 | 6.0 | 0.96 | 0.72 | 1.02 |
| 5 | 4.5 | 1.35 | 0.96 | 0.37 |
| 6 | 3.0 | 2.65 | 0.53 | 0.29 |

Gene 1: matrix metalloproteinase 1
Gene 2: Protein Kinase C Beta
Gene 3: TGF-beta 1 (transforming growth factor)

The data show the relative fold change of gene expression between first and seventh day of treatment ranked against performance over full 12 weeks of treatment in terms of Performance Quotient. In other words, it is possible to tell in 7 days what will happen in 12 weeks. The data may be included in the knowledge base useful for the business method of the present invention. Specifically, this association between visual grading on a Crepey Grade scale with gene changes in response to product treatments, is entered into the knowledge base. Similar correlations may be made part of the knowledge base for measures of photodamage, mottle pigmentation, height of wrinkles, lipid matrix (e.g. to predict penetration), and other conditions of skin or personal care attributes.

### EXAMPLE 3

This example demonstrates the business method of the present invention.

A consumer performs a non-invasive diagnostic test for a particular personal care condition and inputs the results into the computer system incorporating a knowledge base in accordance with the present invention. The knowledge base contains gene expression data to tell whether there is room for improvement. The computer system correlates the non-invasive diagnostic result to how others responded based on gene expression and recommends a suitable cosmetic product.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A method of providing a system of selecting a treatment product for a skin condition of a consumer, the method comprising:
a) collecting information from said consumer regarding a plurality of characteristics associated with said skin condition;
b) inputting the information into a computerized knowledge system that selects a product that will be effective for said consumer from at least two products that are effective against said skin condition; and
c) providing the consumer with the treatment product for treating the skin condition;
wherein the computerized knowledge system is derived from a correlation is between responses of a population of individuals to a plurality of products and measured characteristics of each of the individuals prior to use of the plurality of products.

2. A method of providing a system of selecting a treatment product for a skin condition of a consumer, the method comprising the steps of:
a) collecting information from said consumer regarding a plurality of characteristics associated with said skin condition, the information collected through a computer;
b) inputting the information into a computerized knowledge system that selects a product that will be effective for the consumer from at least two products that are effective against the skin condition; and
c) providing the consumer with the treatment product for treating the skin condition;
wherein the computerized knowledge system is derived from a correlation between responses of a population of individuals to a plurality of products and measured characteristics of each of the individuals prior to use of the plurality of products.

3. The method of claim 2 wherein the providing step (c) comprises the steps of:
(c1) identifying the treatment product for treating the consumer's skin condition; and
(c2) supplying the treatment product to the consumer through a computer ordering system.

4. The method of claim 1, wherein the responses of the population of individuals to the plurality of products, that are required to generate the computerized knowledge system, are determined by applying multiple products to small areas of skin for a period of time less than that required to show ultimate clinical benefit and measuring at the end of that short time a change in a skin property or properties that is predictive of the eventual clinical benefit.

5. The method of claim 2, wherein the responses of the population of individuals to the plurality of products, that are required to generate the computerized knowledge system, are determined by applying multiple products to small areas of skin for a period of time less than that required to show ultimate clinical benefit and measuring at the end of that short time a change in a skin property or properties that is predictive of the eventual clinical benefit.

6. The method of claim 3, wherein the skin property measured is selected from the group consisting of autofluorescence, texture, optical transmission or remittance, electrical property, chemical composition.

7. A method for predicting the efficacy of at least one product comprising:
a) measuring an initial mRNA content, determining an initial gene expression of a predetermined area of a human epidermis, or a combination thereof;
b) measuring a final mRNA content or determining a final gene expression of said predetermined area of said epidermis after said product has been applied;
c) assessing a change in mRNA content or a change in gene expression; and
d) predicting efficacy of said product from said change in mRNA content or said change in gene expression,
wherein said initial mRNA content is measured or said initial gene expression is determined prior to or after the application of said product to said predetermined area of said epidermis.

8. The method of claim 7, wherein the change in skin property predictive of ultimate benefit is the change in gene expression.

9. The method of claim 1, further comprising providing feedback to said consumer regarding the efficacy of said selected product.

10. The method of claim 7, wherein said method is used to assess the efficacy of a plurality of products simultaneously.

11. The method of claim 1, further comprising monitoring efficacy of said supplied treatment product by protein measurement techniques or instrumental techniques.
